(19) United States
(12) Patent Application Publication
(10) Pub. No.: US 2015/0106207 A1
(43) Pub. Date: Apr. 16, 2015

(54) METHOD OF PROVIDING FORWARDING ADVERTISEMENT SERVICE IN MOBILE DEVICE

(71) Applicant: Chang Hun LEE, (US)

(72) Inventor: Chang Hun Lee, Goyang-si (KR)

(21) Appl. No.: 14/389,032

(22) PCT Filed: Mar. 27, 2013
(86) PCT No.: PCT/KR2013/002562

§ 371 Date: Sep. 29, 2014

(30) Foreign Application Priority Data
Mar. 27, 2012 (KR) 10-2012-0031121

(51) Int. Cl. G06Q 30/02

(52) U.S. Cl. CPC G06Q 30/0267
USPC 705/14.64

(57) ABSTRACT

The present invention proposes a method of providing a forwarding advertisement service in a mobile device, wherein a service providing server receives an advertisement forwarding signal from a mobile device, and forwards to a predetermined advertisement medium an advertisement assigned according to execution information on an application program that is installed in the mobile device. Thus, a user may not be exposed to an advertisement when the application program is executed in the mobile device. As a result, the user may get rid of any inconvenience and cumbersomeness due to the display of advertisements, and pay attention to the main content of the application program.

### TECHNICAL FIELD

The present invention relates generally to a method of providing an adverting service and, more particularly, to a method of providing a forwarding advertisement service via a mobile device.

### BACKGROUND ART

Recently, with the popularization of small-sized electronic devices and the rapid development of mobile communication technology, it has become increasingly common for people to carry one or more mobile devices. Mobile devices are highly advantageous as an advertising means in that the time of day for which each person uses his or her mobile device is lengthened, and the person almost always has a mobile device, such as a mobile communication terminal, at hand.

Conventional advertising methods via a mobile device are generally implemented by broadcasting advertisement messages or advertisement images using a Short Message Service (SMS) or a Multimedia Message Service (MMS). Recently, as smart devices such as a smart phone, a smart note, and a tablet Personal Computer (PC) have become widely popularized, the users of such smart devices have increased. Further, since smart devices can be used by installing various application programs therein, there is a strong possibility of providing advertisements via the application programs. Since the Internet can be accessed via the smart devices, various advertisements can be actively provided.

In the conventional methods of providing advertisements via a mobile device such as a smart device, an advertisement was inserted by including a banner to a part of the screen of an application program and by linking an advertisement or a site to the banner. Since such a method is very similar to that of a conventional web-based banner advertisement type, users are generally not interested in such an advertisement or cannot use the part of the screen, there is a limitation in that the users feel repulsed and are inconvenienced. Further, a problem arises in that users tend to concentrate on main content displayed on the screen, thus reducing advertising effects based on banner advertisements.

### DISCLOSURE

### Technical Problem

Accordingly, the present invention has been made keeping in mind the above problems occurring in the prior art, and an object of the present invention is to provide a method of providing a forwarding advertisement service via a mobile device, in which a service provision server receives an advertisement forwarding signal from the mobile device, and forwards allocated advertisements to a predefined advertising medium depending on execution information for an application program installed in the mobile device, so that a user may not be exposed to the advertisements while the application program is executed on the mobile device, thus overcoming inconvenience and complications caused by the display of advertisements, and allowing the user to concentrate on the main content of the application program.

Another object of the present invention is to provide a method of providing a forwarding advertisement service via a mobile device, which further forwards an additional advertisement upon forwarding advertisements, and exposes a user to more advertisements when he or she is exposed to advertisements via an advertising medium than when exposed to advertisements via an application program, thus improving advertising effects, and which allows the user to be positively exposed to advertisements by providing benefits to the user exposed to advertisements via the advertising medium, thus improving the user's degree of concentration on advertisements.

### Technical Solution

A method of providing a forwarding advertisement service via a mobile device according to an aspect of the present invention to accomplish the above objects is performed by a service provision server that provides an advertisement to a mobile device, in which an application program with an advertisement code inserted thereinto is installed, and includes (1) inputting an advertisement forwarding signal from the mobile device; (2) receiving execution information for the application program installed in the mobile device; (3) forwarding an advertisement, allocated to the application program, to a predefined advertising medium depending on the received execution information, wherein the method is characterized in the configuration thereof in that mobile device hides the allocated advertisement to be displayed during execution of the application program.

Preferably, the advertisement forwarding signal may be a signal for a drag operation performed in a predefined direction, or a touch or click signal made in a predefined pattern.

Preferably, the execution information may include an execution time of the application program or location information of the mobile device.

Preferably, the method may further include, before (1), inputting setting of the predefined advertising medium from a user.

Preferably, (3) may be configured to further forward an additional advertisement to the predefined advertising medium.

Preferably, the method may further include, after (3), (4) receiving a display request for the forwarded advertisement from the mobile device or the user′ additional device that uses the advertising medium; and (5) transmitting the advertisement forwarded at (3) or an advertisement corresponding to the forwarded advertisement to the advertising medium in response to the received display request.

More preferably, the advertising medium may be an advertising application program installed in the mobile device or the user's additional device.

More preferably, (4) may be configured to further receive location information of the advertising medium, and (5) may be configured to transmit the advertisement corresponding to the forwarded advertisement to the advertising medium using the received location information.

More preferably, the method may further include, after (5), providing benefits to the user exposed to the advertisement transmitted to the advertising medium at (5).

### Advantageous Effects

In accordance with the method of providing a forwarding advertisement service via a mobile device proposed in the present invention, a service provision server receives an advertisement forwarding signal from the mobile device, and forwards allocated advertisements to a predefined advertising medium depending on execution information for an application program installed in the mobile device, so that a user may not be exposed to the advertisements while the application program is executed on the mobile device, thus overcoming inconvenience and complications caused by the display of advertisements, and allowing the user to concentrate on the main content of the application program.

Further, in accordance with the present invention, the present invention further forwards an additional advertisement upon forwarding advertisements and exposes a user to more advertisements when he or she is exposed to advertisements via an advertising medium than when exposed to advertisements via an application program, thus improving advertising effects, and the present invention allows the user to be positively exposed to advertisements by providing benefits to the user exposed to advertisements via the advertising medium, thus improving the user's degree of concentration on advertisements.

### DESCRIPTION OF DRAWINGS

FIG. 1 is a diagram showing an advertisement provided via a mobile device using a conventional application program;

FIG. 2 is a diagram showing the configuration of a system for implementing a method of providing a forwarding advertisement service via a mobile device according to an embodiment of the present invention;

FIG. 3 is a flowchart showing the flow of the method of providing a forwarding advertisement service via a mobile device according to an embodiment of the present invention;

FIG. 4 is a diagram showing an example of the screen of a mobile device, on which step S10 is performed, in the method of providing a forwarding advertisement service via a mobile device according to an embodiment of the present invention;

FIG. 5 is a diagram showing an example of the screen of the mobile device, on which step S100 is performed, in the method of providing a forwarding advertisement service via a mobile device according to an embodiment of the present invention;

FIG. 6 is a flowchart showing the detailed flow of a procedure for providing a forwarded advertisement to a user, in the method of providing a forwarding advertisement service via a mobile device according to an embodiment of the present invention;

FIG. 7 is a diagram showing an example of the screen of the mobile device, on which step S500 is performed, in the method of providing a forwarding advertisement service via a mobile device according to an embodiment of the present invention; and

FIG. 8 is a diagram showing an example of the screen of the mobile device, on which step S600 is performed, in the method of providing a forwarding advertisement service via a mobile device according to an embodiment of the present invention.

### DESCRIPTION OF THE REFERENCE NUMERALS IN THE DRAWINGS

100: service provision server 200: mobile device
300: advertising medium
S10: step of inputting settings of predefined advertising medium from user
S100: step of inputting advertisement forwarding signal from mobile device
S200: step of receiving execution information for application program installed in mobile device
S300: step of forwarding advertisement, allocated to application program, to predefined advertising medium depending on execution information
S400: step of receiving display request for forwarded advertisement
S500: step of transmitting forwarded advertisement or advertisement corresponding to forwarded advertisement to advertising medium
S600: step of providing benefits to user exposed to advertisement

### BEST MODE

Preferred embodiments of the present invention are described with reference to the accompanying drawings in order to describe the present invention in detail so that those having ordinary knowledge in the technical field to which the present invention pertains can easily practice the present invention. In the following detailed description of the preferred embodiments of the present invention, detailed descriptions of related known functions or configurations which are deemed to make the gist of the present invention obscure will be omitted. Further, it should be noted that the same reference numerals are used to designate elements for performing similar functions and operations throughout the drawings.

Throughout the entire specification, it should be understood that a representation indicating that a first component is “connected” to a second component may include the case where the first component is “indirectly connected” to the second component with some other component interposed therebetween, as well as the case where the first component is “directly connected” to the second component. Further, it should be understood that a representation such as “including” a certain component means that other components may be further included without excluding a possibility that other components will be added unless a description to the contrary is specifically pointed out in context.

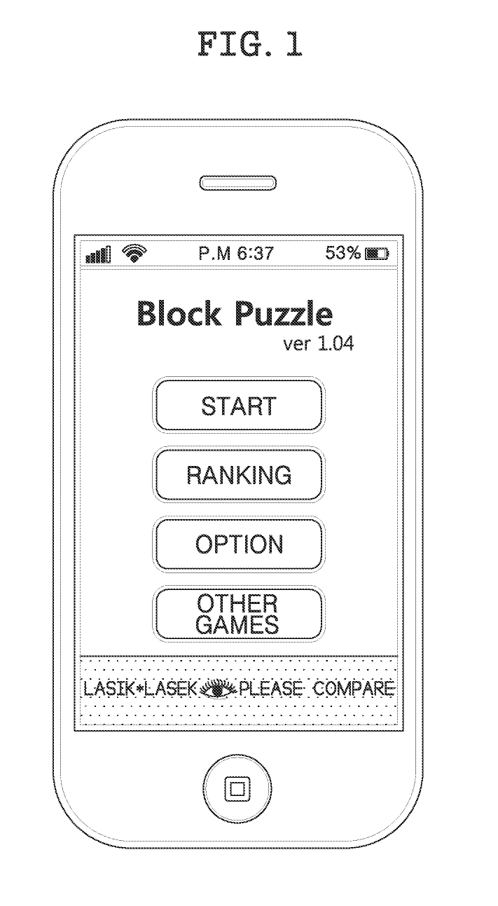

FIG. 1 is a diagram showing an advertisement provided via a mobile device using a conventional application program. As shown in FIG. 1, the advertisement provided via the mobile device using the conventional application program adopts a form in which a banner advertisement together with the main content of the application program are displayed and a link to the banner is set up, and in which, when a user clicks the banner, the screen of the mobile device moves to a page for detailed information, the website of an advertiser, or an application store. Such a banner advertisement is the most basic form, and is installed on most free application programs to yield developer profit. However, there is a problem in that it is difficult for the user to take more interest in the banner advertisements than that in conventional web-based banner advertisements, and the user is aware that such an advertisement reduces the size of a main display area in which an application program is executed, thus creating a feeling of inconvenience and repulsion, and decreasing advertising effects due to such negative awareness.

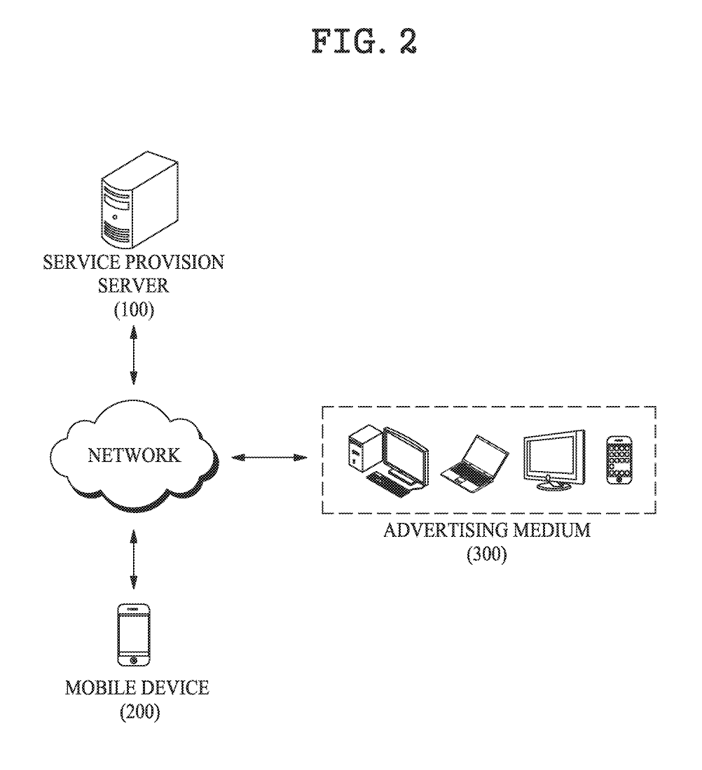

FIG. 2 is a diagram showing the configuration of a system for implementing a method of providing a forwarding advertisement service via a mobile device 200 according to an embodiment of the present invention, which can solve the above-described problems of the conventional methods. As shown in FIG. 2, the system for implementing the method of providing a forwarding advertisement service via the mobile device 200 according to the embodiment of the present invention may be configured to include a service provision server 100, the mobile device 200, and an advertising medium 300.

That is, in the present invention, the service provision server 100 inputs an advertisement forwarding signal from the mobile device 200, forwards an allocated advertisement to the predefined advertising medium 300 depending on execution information for an application program installed in the mobile device 200, so that the user may not be exposed to an advertisement while the application program is executed on the mobile device 200, thus solving the inconvenience and complications caused by the display of an advertisement, and allowing a user to concentrate on the main content of the application program.

Further, the present invention further forwards an additional advertisement upon forwarding advertisements, so that advertising effects can be improved by exposing the user to more advertisements when he or she is exposed to advertisements via the advertising medium 300 than when exposed to the advertisements via the application program, and so that the user may be positively exposed to advertisements and the degree of concentration on advertisements may be improved by providing benefits to the user exposed to advertisements via the advertising medium 300.

Below, individual components of the system for implementing the method of providing a forwarding advertisement service via the mobile device 200 according to an embodiment of the present invention will be described in detail.

The service provision server 100 is a server for providing an advertisement to the mobile device 200 into which an advertisement code is inserted. When the application program into which an advertisement code is inserted is executed, the service provision server 100 may provide the corresponding advertisement to a user by transmitting the advertisement to the mobile device 200. In this case, the service provision server 100 may forward an advertisement to be displayed as a banner to the predefined advertising medium 300, as shown in FIG. 1. By forwarding the advertisement, the user may use the main content, without reducing the size of the display area due to the advertisement, in the screen provided by the application. Meanwhile, the service provision server 100 may permit the connection of the mobile device 200 and the advertising medium 300 and transmit or receive various types of signals and data over a network including the Internet, the Intranet, a wired/wireless communication network, a mobile communication network, etc.

The mobile device 200 may be the terminal of the user who desires to use a forwarding advertisement service provided by the service provision server 100. The present invention may forward an advertisement allocated to the application program to the advertising medium 300, and the mobile device 200 may hide the allocated advertisement upon executing the application program, thus enabling only the main content to be displayed on the screen. The mobile device 200 may be a smart phone, a smart note, a tablet PC, an MP4 player, or the like, which may be carried and enable application programs to be installed and executed. However, the mobile device 200 according to the present invention is not limited to the types of devices arranged here, and any type of device may be freely used to function as the mobile device 200 of the present invention regardless of the detailed form of terminals, as long as the device is capable of transmitting application program execution information to the service provision server 100 and hiding an allocated advertisement to be displayed during the execution of the application program.

The advertising medium 300 may receive a forwarded advertisement via the service provision server 100. The advertising medium 300 may be an advertising application program installed in the mobile device 200 or another device. In this case, another device may be an additional mobile device of the user, a computer, a notebook or a smart TV. In addition, the advertising medium may also be the messenger, social network service (SNS), or email of the user, and thus the user may receive the forwarded advertisement using various types of methods.

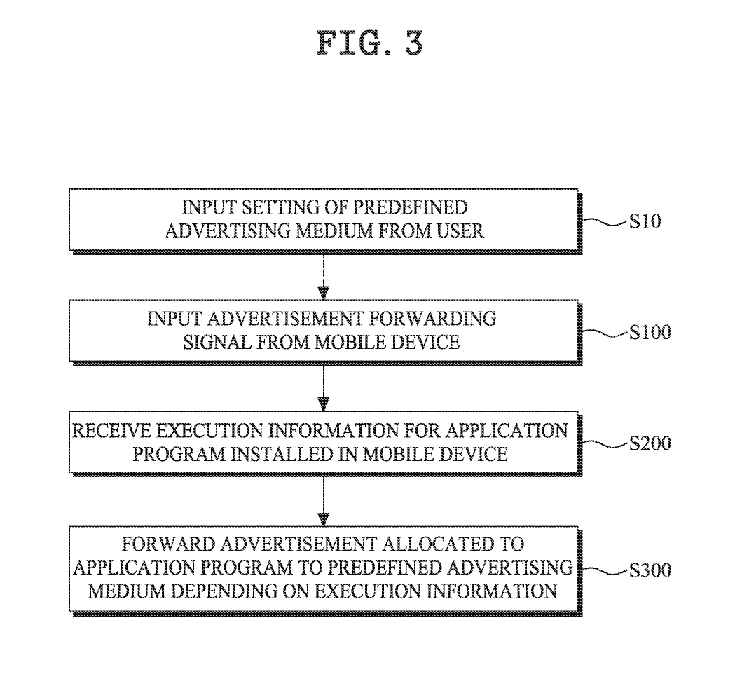

FIG. 3 is a flowchart showing the flow of the method of providing a forwarding advertisement service via the mobile device 200 according to an embodiment of the present invention. As shown in FIG. 3, the method of providing a forwarding advertisement service via the mobile device 200 according to the embodiment of the present invention may be implemented to include the step S100 of inputting an advertisement forwarding signal from the mobile device 200, the step S200 of receiving execution information for an application program installed in the mobile device 200, and the step S300 of forwarding an advertisement allocated to the application program to a predefined advertising medium 300 depending on the execution information, and may be implemented to further include the step S10 of inputting the setting of the predefined advertising medium 300 from a user.

At step S10, the service provision server 100 may input the setting of the predefined advertising medium 300 from the user. That is, at step S10, the user may personally set the advertising medium 300 that desires to receive a forwarded advertisement. At step S10, the setting of one or more advertising media 300 may be input. When a plurality of advertising media 300 is set, the advertisement may be forwarded to all of the set advertising media 300.

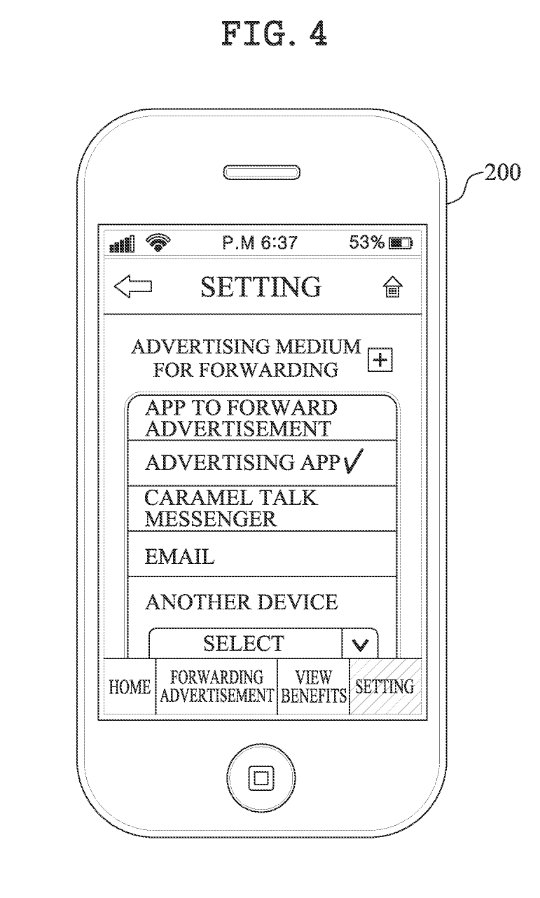

FIG. 4 is a diagram showing an example of the screen of the mobile device 200, on which step S10 is performed, in the method of providing a forwarding advertisement service via the mobile device 200 according to an embodiment of the present invention. As shown in FIG. 4, at step S10 in the method of providing a forwarding advertisement service via the mobile device 200 according to the embodiment of the present invention, an advertising medium 300 that desires to receive an advertisement may be input by the user. FIG. 4 illustrates a screen on which an advertising application program for implementing the method of providing a forwarding advertisement service via the mobile device 200 according to the embodiment of the present invention may be installed and executed in the mobile device 200. By utilizing the user interface of the advertising application program, the advertising medium 300 may be easily input and set. In this case, the term “App to forward” denotes an application program that will forward an advertisement. For example, all advertisements that are to be transmitted during the execution of the corresponding application program are forwarded in advance and are displayed, and then subsequent main content may be displayed. Meanwhile, “Advertising App” may refer to an advertising application program for implementing the method of providing a forwarding advertisement service via the mobile device 200 according to the embodiment of the present invention. When the corresponding advertising medium 300 is selected, and the user executes the advertising application program, forwarded advertisements may be collected and displayed.

At step S100, the service provision server 100 may receive an advertisement forwarding signal from the mobile device 200. In this case, the advertisement forwarding signal may be a signal for a drag operation performed in a predefined direction, or a touch or click signal made in a predefined pattern. For example, when the application program that will forward advertisements is previously registered by the user in the mobile device 200, and the registered application program is executed, the mobile device 200 may send an advertisement forwarding signal to the service provision server 100. Alternatively, when the user requests the forwarding of advertisements allocated to the executed application program by performing a drag operation in a predetermined direction using the input unit of the mobile device 200 or by performing a predefined touch or click operation while executing the application program, the mobile device 200 that receives such a signal may transmit an advertisement forwarding signal to the service provision server 100. That is, since there may be a case where an advertisement is not necessarily inserted into all application programs, and an advertisement may not greatly interfere with the playing of main content, the advertisement forwarding signal may be input from the mobile device 200 at step S100.

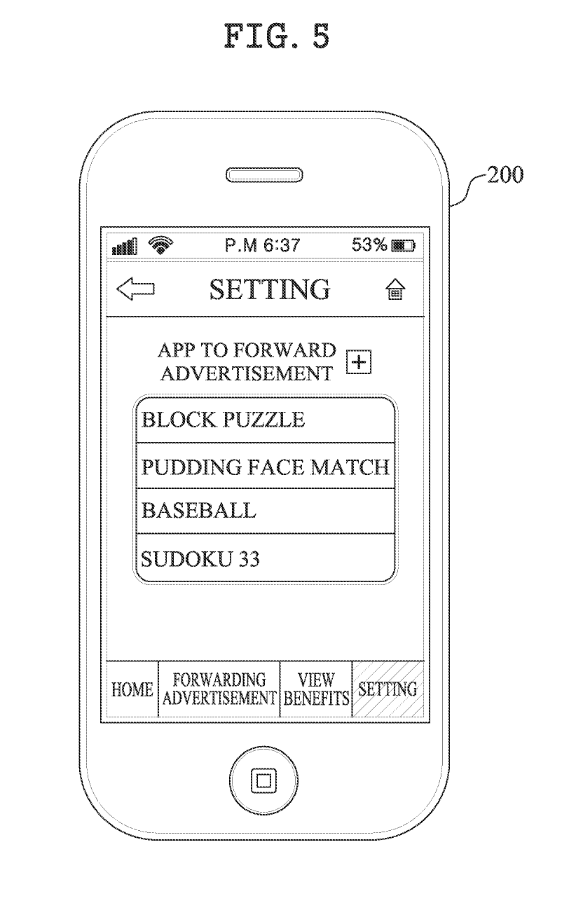

FIG. 5 is a diagram showing an example of the screen of the mobile device 200, on which step S100 is performed, in the method of providing a forwarding advertisement service via the mobile device 200 according to an embodiment of the present invention. As shown in FIG. 5, at step S100 in the method of providing a forwarding advertisement service via the mobile device 200 according to the embodiment of the present invention, an application program that will forward advertisements may be registered and set. When setting is made as shown in FIG. 5, and the registered application program is executed, the mobile device 200 may automatically send an advertisement forwarding signal to the service provision server 100.

At step S200, the service provision server 100 may receive execution information for the application program installed in the mobile device 200. In this case, the execution information may be information required by the service provision server 100 to allocate advertisements to the application program that is executed. More specifically, the execution information may include the execution time of the application program or the location information of the mobile device 200, and may further include additional information required to allocate advertisements.

At step S300, the service provision server 100 may forward the advertisements, allocated to the application program, to the predefined advertising medium 300 depending on the received execution information. For example, when the service provision server 100 updates and transmits advertisements at regular time intervals, the type and number of advertisements may be allocated using the execution time of the application. When advertisements are allocated based on the location of the mobile device 200, advertisements may be allocated using the location information included in the execution information.

At step S300, the allocated advertisements may be forwarded to the advertising medium 300 predefined at step S10. In this case, the forwarding of advertisements may mean that advertisements such as actual banners, created in the form of text, images, sound or video, are transferred to the advertising medium 300. However, in some embodiments, the forwarding of advertisements may mean that forwarding information such as the number or type of forwarded advertisements is transferred to the advertising medium 300 so that forwarded advertisements may be changed depending on the situation in which actual displaying is performed.

Further, at step S300, an additional advertisement may be further forwarded to the predefined advertising medium 300. That is, in the method of providing a forwarding advertisement service via the mobile device 200 according to the embodiment of the present invention, advertisements to be displayed together with main content during the execution of the application program are forwarded and viewed on the separate advertising medium 300, and thus the additional advertisement may be further forwarded to the advertising medium 300 so that the user may be exposed to more advertisements upon viewing the advertisements on the advertising medium 300.

Meanwhile, the mobile device 200 that has forwarded the advertisements allocated at step S300 may hide the allocated advertisements upon executing the application program. That is, since the advertisements allocated to the application program have already been forwarded, the service provision server 100 may neither transmit nor output advertisements to the mobile device 200 during the execution of the corresponding application program. Therefore, the user may use the screen in which the size of a display area for main content is not reduced, and may solve complications and inconvenience caused by advertisements.

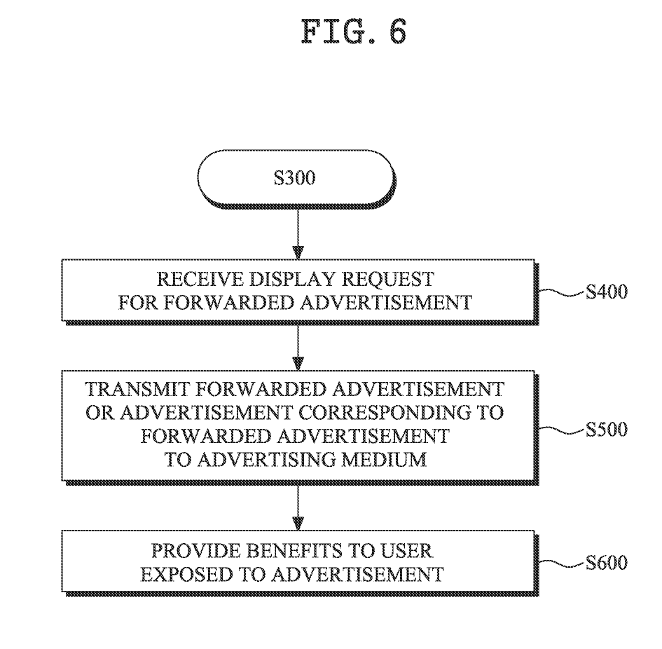

FIG. 6 is a flowchart showing the detailed flow of a procedure for providing a forwarded advertisement to the user in the method of providing a forwarding advertisement service via the mobile device 200 according to an embodiment of the present invention. As shown in FIG. 6, the method of providing a forwarding advertisement service via the mobile device 200 according to the embodiment of the present invention may provide a forwarded advertisement to the user by including the step S400 of receiving a display request for the forwarded advertisement, and the step S500 of transmitting the forwarded advertisement or an advertisement corresponding to the forwarded advertisement to the advertising medium 300, and may further include the step S600 of providing benefits to a user exposed to advertisements.

At step S400, the service provision server 100 may receive a display request for the forwarded advertisement. That is, when the user desires to view the forwarded advertisement via the advertising medium 300, an advertisement display request may be sent to the service provision server 100. A device that sends the advertisement display request to the service provision server 100 may be the mobile device 200 or the user's additional device that uses the advertising medium 300.

Meanwhile, at step S400, the location information of the advertising medium 300 may be further received. Most of electronic devices that are recently popularized are capable of utilizing location information based on a Global Positioning System (GPS) or over a communication network. Therefore, the service provision server 100 may further receive location information, together with an advertisement display request, from the mobile device 200 or the user's additional device that is intended to display the advertising medium 300.

At step S500, the service provision server 100 may transmit each advertisement forwarded at step S300 or the advertisement corresponding to the forwarded advertisement to the advertising medium 300 in response to the received display request. For example, if the advertisement forwarded at step S300 is a text, image, sound or video-type advertisement, the corresponding advertisement may be immediately transmitted and displayed on the advertising medium 300.

Meanwhile, when forwarding information such as the number or type of forwarded advertisements is transferred to the advertising medium 300 so that the advertisements forwarded at step S300 may be changed depending on the situation in which actual displaying is performed, advertisements corresponding to the forwarded advertisements may be transmitted to the advertising medium 300. In this case, the advertising medium 300 may be an advertising application program installed in the mobile device 200 or the additional device. In particular, the time at which the advertisements are forwarded at step S300 may be different from the time at which the advertisements are transmitted to the advertising medium 300 at step S500, and the location of the user may also differ at respective times. Therefore, at step S500, advertisements corresponding to the forwarded advertisements may be transmitted to the advertising medium 300 using the received location information, and thus region-based advertisements may be effectively provided.

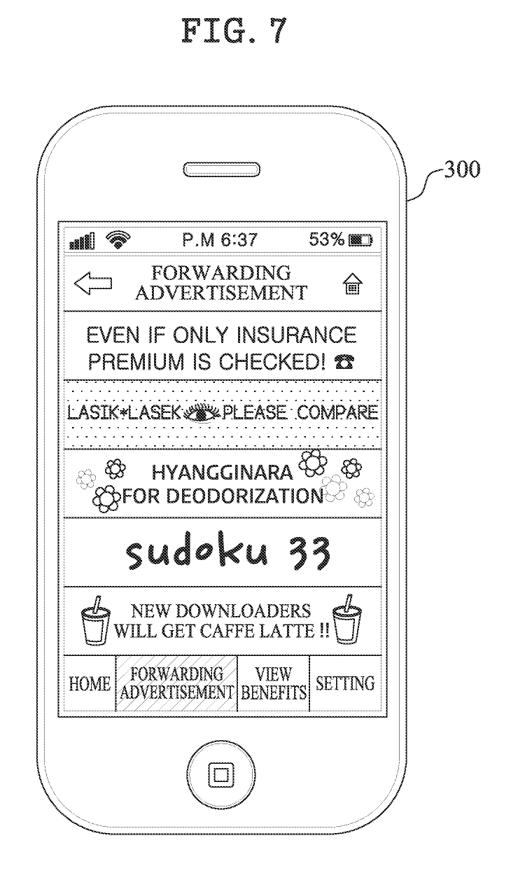

FIG. 7 is a diagram showing an example of the screen of the mobile device 200, on which step S500 is performed, in the method of providing a forwarding advertisement service via the mobile device 200 according to an embodiment of the present invention. As shown in FIG. 7, at step S500 in the method of providing a forwarding advertisement service via the mobile device 200 according to the embodiment of the present invention, the advertisements transmitted from the service provision server 100 may be displayed using the advertising application program installed in the mobile device 200 or the user's additional device. As shown in FIG. 7, at step S500, banner advertisements or the like, such as those shown in FIG. 1, may be collected and simultaneously provided.

At step S600, the service provision server 100 may provide benefits to the user exposed to the advertisements transmitted to the advertising medium 300 at step S500. After the user forwards the advertisements at step S300 and uses the application without feeling repulsion, he or she may not actually view the forwarded advertisements. Therefore, benefits such as points, mileage, or coupons are provided to the user exposed to advertisements at step S600, thus enticing the user to more actively view the forwarded advertisements.

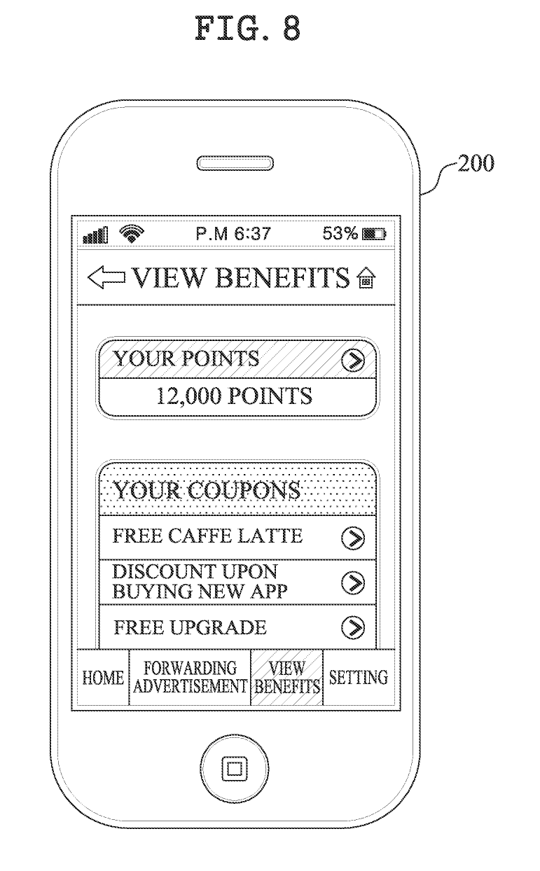

FIG. 8 is a diagram showing an example of the screen of the mobile device 200, on which step S600 is performed, in the method of providing a forwarding advertisement service via the mobile device 200 according to an embodiment of the present invention. As shown in FIG. 8, at step S600 in the method of providing a forwarding advertisement service via the mobile device 200 according to the embodiment of the present invention, benefits may be provided as a reward to the user for viewing the advertisements based on the transmission of the advertisements at step S500. Further, the benefits provided to the user may be collected and viewed, and information about detailed items, methods of using benefits, and affiliated stores, in which benefits can be used, may also be provided.

The above-described present invention may be modified or applied in various manners by those skilled in the art to which the present invention pertains, and the technical scope of the present invention should be defined by the accompanying claims.

1. A method of providing a forwarding advertisement service via a mobile device, the method being performed by a service provision server that provides an advertisement to a mobile device, in which an application program with an advertisement code inserted thereinto is installed, comprising:
(1) inputting an advertisement forwarding signal from the mobile device;
(2) receiving execution information for the application program installed in the mobile device;
(3) forwarding an advertisement, allocated to the application program, to a predefined advertising medium depending on the received execution information;
(4) receiving a display request for the forwarded advertisement from the mobile device or a user's additional device that uses the advertising medium; and
(5) transmitting the advertisement forwarded at (3) or an advertisement corresponding to the forwarded advertisement to the advertising medium in response to the received display request,
wherein the mobile device hides the allocated advertisement to be displayed during execution of the application program, and
wherein the advertising medium is at least one of an advertising application program installed in the mobile device or the user's additional device, the user's messenger, the user's social network service (SNS), and the user's email.

2. The method of claim 1, wherein the advertisement forwarding signal is a signal for a drag operation performed in a predefined direction, or a touch or click signal made in a predefined pattern.

3. The method of claim 1, wherein the execution information includes an execution time of the application program or location information of the mobile device.

4. The method of claim 1, further comprising, before (1), inputting setting of the predefined advertising medium from the user.

5. The method of claim 1, wherein (3) is configured to further forward an additional advertisement to the predefined advertising medium.

6. The method of claim 1, wherein (4) is configured to further receive location information of the advertising medium, and (5) is configured to transmit the advertisement corresponding to the forwarded advertisement to the advertising medium using the received location information.

7. The method of claim 1, further comprising, after (5), providing benefits to the user exposed to the advertisement transmitted to the advertising medium at (5).
